(19) United States
(12) Patent Application Publication
(10) Pub. No.: US 2010/0107873 A1
(43) Pub. Date: May 6, 2010

(54) METHOD FOR REMOVING STYRENE

(76) Inventors: Geert Frederik Versteeg, Oldenzaal (NL); Glenn Rexwinkel, Oldenzaal (NL); Sjaak Van Loo, Oldenzaal (NL)

Correspondence Address: STITES & HARBISON PLLC, 1199 NORTH FAIRFAX STREET, SUITE 900, ALEXANDRIA, VA, 22314, US

(21) Appl. No.: 12/526,556

(22) PCT Filed: Feb. 14, 2008
(86) PCT No.: PCT/IB08/50537

§ 371 Date: Jan. 11, 2010

(30) Foreign Application Priority Data
Feb. 15, 2007 (ZA) 2007/01346

(51) Int. Cl. B01D 53/04

(52) U.S. Cl. 95/106; 95/144; 95/95

(57) ABSTRACT

The invention discloses a method for removing styrene from waste airstreams and for purifying styrene, in which a waste airstream including styrene is passed through synthetic hydrophobic sorbent particles so that styrene from the waste airstream is adsorbed by the synthetic hydrophobic sorbent particles resulting in an airstream substantially free from styrene or substantially purified styrene.

### FIELD OF INVENTION

The present invention relates to a method for removing styrene.

More particularly, the present invention relates to a method for removing styrene from waste airstreams.

### BACKGROUND TO INVENTION

Styrene emissions have become a major concern in most industrialized countries. Legislation, aimed at minimizing these emissions, is creating serious problems for styrene processing industries, such as the fibre reinforced plastics industry.

If industries and factories do not implement measures to reduce styrene emissions, many of them will be forced to shutdown in the near future.

It is an object of the invention to suggest a method for removing styrene from waste airstreams, which will assist in overcoming these problems.

### SUMMARY OF INVENTION

According to the invention, a method for removing styrene from waste airstreams, includes the steps
(a) of passing a waste airstream including styrene through synthetic hydrophobic sorbent particles; and
(b) of adsorbing the styrene from the waste airstream by means of the synthetic hydrophobic sorbent particles resulting in an airstream substantially free from styrene.

Also according to the invention, a method for purifying styrene, includes the steps
(a) of passing styrene in an airstream through synthetic hydrophobic sorbent particles; and
(b) of adsorbing the styrene from the airstream by means of the synthetic hydrophobic sorbent particles resulting in substantially purified styrene.

The synthetic hydrophobic sorbent particles may be provided in an adsorbent bed.

Sufficient synthetic hydrophobic sorbent particles may be provided to remove 99.999% of all styrene from the waste air stream.

The absorbent bed may be a flat packed bed.

The synthetic hydrophobic sorbent particles may have a particle size between 200 and 1000 μm, e.g. between 350 and 600 μm.

The method may include the step of regenerating the synthetic hydrophobic sorbent particles.

The method may include the step of regenerating the synthetic hydrophobic sorbent particles when they have become saturated.

The method may include the step of regenerating the synthetic hydrophobic sorbent particles at a temperature not exceeding 110° C.

The method may include the step of regenerating the synthetic hydrophobic sorbent particles using saturated steam of 100-120° C.

Between 1 and 8 kgs of steam may be used to regenerate 1 kg of synthetic hydrophobic sorbent particles.

Between 3 and 4 kgs of steam may be used to regenerate 1 kg of synthetic hydrophobic sorbent particles.

The regeneration time may be more than 1 hour.

The method may include the step of condensing and cooling the steam.

The step of condensing and cooling may take place at a temperature below 30° C. to provide a water and styrene mixture.

Phase separation between water and styrene may occur.

The styrene may float on top of the water and styrene mixture.

The method may include the step of removing the styrene from the water and styrene mixture by means of a settler to obtain removed styrene and remaining water with styrene.

The remaining water with styrene may be used for the production of steam for the regeneration of the synthetic hydrophobic sorbent particles.

The pressure drop across the adsorbent bed may be minimized by using shallow packed adsorbent cartridges containing the synthetic hydrophobic sorbent particles.

Each cartridge may consist of a flat bed of 2 m in length, 25 cm in width and 4 cm in height, the top and bottom of the flat bed being made of wire mesh, with the synthetic hydrophobic sorbent particles inbetween.

The cartridge dimensions may be optimized with respect to pressure drop, adsorber volume and axial flow distribution.

The pressure drop across the adsorbent bed may be less than 10 mbar.

A mechanical vapour recompression (MVR) technique may be used.

A boiler with the mechanical vapour recompression technique may be used.

A blower (in vacuum mode) may be provided to decrease the boiler pressure to 800 mbar resulting in the formation of steam.

The steam formed may be pumped from the boiler to the synthetic hydrophobic sorbent particles.

Due to compression of the steam, the temperature of the steam may be caused to increase to about 120° C.

The method may include the step of regenerating the synthetic hydrophobic sorbent particles by means of synthetic hydrophobic sorbent particles.

The superheated steam may be condensed in a condenser.

The condenser may use cold boiling water (94° C.) from the boiler.

The steam may be condensed in the condenser, the heat of condensation is transported to the boiling water.

Energy may be added to account for unavoidable heat losses.

### DETAILED DESCRIPTION OF INVENTION

The invention suggests methods for recovering styrene from a waste airstream or purifying styrene. For this purpose an apparatus is also suggested.

The invention suggests the following methods:

### Method A:

A method for removing styrene from waste airstreams, which includes the steps
(a) of passing a waste airstream including styrene through synthetic hydrophobic sorbent particles; and
(b) of adsorbing the styrene from the waste airstream by means of the synthetic hydrophobic sorbent particles resulting in an airstream substantially free from styrene.

### Method B:

A method for purifying styrene, which includes the steps
(a) of passing styrene in an airstream through synthetic hydrophobic sorbent particles; and
(b) of adsorbing the styrene from the airstream by means of the synthetic hydrophobic sorbent particles resulting in substantially purified styrene.

In certain conditions the method can remove 99.999% of all styrene from the waste air streams.

The synthetic hydrophobic sorbents generally have a particle size between 200 and 1000 μm, but preferably between 350 and 600 μm.

During the adsorption step, the sorbent particles become more and more saturated and after a certain stand time the sorbent particles are completely saturated and are unable to remove anymore styrene from the waste air stream. When saturation is reached the sorbent particles need to be regenerated.

Extensive research has shown that above 120° C. polymerization of the styrene inside the pores of the adsorbent starts to occur, which results in a decreasing number of adsorption sites. Thus in order to maintain a constant high adsorption capacity, regeneration temperatures should not exceed 120° C., and preferably not exceed 110° C. At 110° C. between 1 and 8 kgs of steam are needed to regenerate 1 kg of sorbent. Optimal values are found between 3 and 4 kgs of steam per kg of sorbent. The regeneration time should be longer than 1 hour, preferably longer than 2 hours and more preferably longer than 3 hours.

The steam and styrene gas mixture is condensed and cooled below 30° C. During this process a phase separation between water and styrene occurs because styrene is only slightly soluble in water (0.31 g/litre). The styrene layer is floating on top of the water layer where it can easily be separated using a settler. The remaining water is saturated with styrene (0.31 g/litre) and can be reused for the production of steam for the regeneration of the sorbent particles. Research has shown that the presence of the styrene in the water does not influence the regeneration efficiency.

In order to be able to operate the styrene removal system at minimal operational cost several measures have been taken. Firstly, the pressure drop across the adsorbent bed has been minimized by using shallow packed adsorbent cartridges. The cartridges are formed by a flat bed of 2 m in length, 25 cm in width and 4 cm in height, an inner wire mesh screen and an outer wire mesh screen, with in between the sorbent particles. The cartridge dimensions have been optimized with respect to pressure drop, adsorber volume and axial flow distribution. Optimized dimensions for a cartridge with a maximum flow of 250 m³/hour are inner diameter 90 mm, outer diameter 160 mm and length 1000 mm. A typical cartridge of this size has a standtime, at a styrene concentration at operational conditions of 25 ppm, of more than 10 hours. The pressure drop across the packed bed is less than 10 mbar (<8 kW for 40.000 m³/hour for 160 cartridges).

Secondly, a mechanical vapour recompression (MVR) technique is installed. A blower (in vacuum mode) is used to decrease the boiler pressure to 800 mbara. At this temperature water boils at 94° C. The steam formed at 94° C. is pumped from the boiler to the adsorber. Due to the compression of the steam its temperature increases to about 120° C. After the super heated steam has regenerated the adsorbent particles it is condensed in a condenser which uses the cold boiling water (94° C.) from the boiler. While the steam is condensing in the condenser the heat of condensation is transported to the boiling water, resulting in a very energy efficient system.

Theoretically the heat input from the blower should be enough to keep the process running in a stationary situation. In practice a little energy is needed from the heater to account for unavoidable heat losses.

The method in accordance with the invention, thus provides for a method for recovering styrene from waste airstreams, and for producing clear air that can be reused. The method furthermore has extremely low utility and operational costs.

1. A method for removing styrene from waste airstreams, which includes the steps
(a) of passing a waste airstream including styrene through synthetic hydrophobic sorbent particles; and
(b) of adsorbing the styrene from the waste airstream by means of the synthetic hydrophobic sorbent particles resulting in an airstream substantially free from styrene.

2. A method for purifying styrene, which includes the steps
(a) of passing styrene in an airstream through synthetic hydrophobic sorbent particles; and
(b) of adsorbing the styrene from the airstream by means of the synthetic hydrophobic sorbent particles resulting in substantially purified styrene.

3. A method as claimed in claim 2, in which the synthetic hydrophobic sorbent particles are provided in an adsorbent bed.

4. A method as claimed in claim 2, in which sufficient synthetic hydrophobic sorbent particles are provided to remove 99.999% of all styrene from the waste air stream.

5. A method as claimed in claim 3, in which the absorbent bed is a flat packed bed.

6. A method as claimed in claim 2, in which the synthetic hydrophobic sorbent particles have a particle size between 200 and 1000 μm, e.g. 350 to 600 μm.

7. A method as claimed in claim 2, which includes the step of regenerating the synthetic hydrophobic sorbent particles.

8. A method as claimed in claim 7, which includes the step of regenerating the synthetic hydrophobic sorbent particles when they have become saturated.

9. A method as claimed in claim 7, which includes the step of regenerating the synthetic hydrophobic sorbent particles at a temperature not exceeding 110° C.

10. A method as claimed in claim 2, which includes the step of regenerating the synthetic hydrophobic sorbent particles using saturated steam of 100-120° C.

11. A method as claimed in claim 10, in which between 1 and 8 kgs of steam are used to regenerate 1 kg of synthetic hydrophobic sorbent particles.

12. A method as claimed in claim 10, in which between 3 and 4 kgs of steam are used to regenerate 1 kg of synthetic hydrophobic sorbent particles.

13. A method as claimed in claim 7, in which the regeneration time is more than 1 hour.

14. A method as claimed in claim 11, which includes the step of condensing and cooling the steam.

15. A method as claimed in claim 14, in which the step of condensing and cooling takes place at a temperature below 30° C. to provide a water and styrene mixture.

16. A method as claimed in claim 7, in which phase separation between water and styrene occurs.

17. A method as claimed in claim 15, in which the styrene floats on top of the water and styrene mixture.

18. A method as claimed in claim 15, which includes the step of removing the styrene from the water and styrene mixture by means of a settler to obtain removed styrene and remaining water with styrene.

19. A method as claimed in claim 18, in which the remaining water with styrene is used for the production of steam for the regeneration of the synthetic hydrophobic sorbent particles.

20. A method as claimed in claim 3, in which the pressure drop across the adsorbent bed is minimized by using shallow packed adsorbent cartridges containing the synthetic hydrophobic sorbent particles.

21. A method as claimed in claim 20, in which each cartridge consists of a flat bed of 2 m in length, 25 cm in width and 4 cm in height, the top and bottom of the flat bed being made of wire mesh, with the synthetic hydrophobic sorbent particles inbetween.

22. A method as claimed in claim 20, in which the cartridge dimensions are optimized with respect to pressure drop, adsorber volume and axial flow distribution.

23. A method as claimed in claim 3, in which the pressure drop across the adsorbent bed is less than 10 mbar.

24. A method as claimed in claim 2, in which a mechanical vapour recompression (MVR) technique is used.

25. A method as claimed in claim 24, in which a boiler with the mechanical vapour recompression technique is used.

26. A method as claimed in claim 24, in which a blower (in vacuum mode) is provided to decrease the boiler pressure to 800 mbar resulting in the formation of steam.

27. A method as claimed in claim 26, in which the steam formed is pumped from the boiler to the synthetic hydrophobic sorbent particles.

28. A method as claimed in claim 26, in which, due to compression of the steam, the temperature of the steam is caused to increase to about 120° C.

29. A method as claimed in claim 2, which includes the step of regenerating the synthetic hydrophobic sorbent particles by means of synthetic hydrophobic sorbent particles.

30. A method as claimed in claim 29, in which the superheated steam is condensed in a condenser.

31. A method as claimed in claim 30, in which the condenser uses cold boiling water (94° C.) from the boiler.

32. A method as claimed in claim 31, in which, while the steam is condensed in the condenser, the heat of condensation is transported to the boiling water.

33. A method as claimed in claim 2, in which energy is added to account for unavoidable heat losses.

34. A method as claimed in claim 1, in which the synthetic hydrophobic sorbent particles are provided in an adsorbent bed.

35. A method as claimed in claim 1, in which sufficient synthetic hydrophobic sorbent particles are provided to remove 99.999% of all styrene from the waste air stream.

36. A method as claimed in claim 34, in which the absorbent bed is a flat packed bed.

37. A method as claimed in claim 1, in which the synthetic hydrophobic sorbent particles have a particle size between 200 and 1000 μm, e.g. 350 to 600 μm.

38. A method as claimed in claim 1, which includes the step of regenerating the synthetic hydrophobic sorbent particles.

39. A method as claimed in claim 38, which includes the step of regenerating the synthetic hydrophobic sorbent particles when they have become saturated.

40. A method as claimed in claim 38, which includes the step of regenerating the synthetic hydrophobic sorbent particles at a temperature not exceeding 110° C.

41. A method as claimed in claim 1, which includes the step of regenerating the synthetic hydrophobic sorbent particles using saturated steam of 100-120° C.

42. A method as claimed in claim 41, in which between 1 and 8 kgs of steam are used to regenerate 1 kg of synthetic hydrophobic sorbent particles.

43. A method as claimed in claim 41, in which between 3 and 4 kgs of steam are used to regenerate 1 kg of synthetic hydrophobic sorbent particles.

44. A method as claimed in claim 38, in which the regeneration time is more than 1 hour.

45. A method as claimed in claim 42, which includes the step of condensing and cooling the steam.

46. A method as claimed in claim 45, in which the step of condensing and cooling takes place at a temperature below 30° C. to provide a water and styrene mixture.

47. A method as claimed in claim 38, in which phase separation between water and styrene occurs.

48. A method as claimed in claim 46, in which the styrene floats on top of the water and styrene mixture.

49. A method as claimed in 46, which includes the step of removing the styrene from the water and styrene mixture by means of a settler to obtain removed styrene and remaining water with styrene.

50. A method as claimed in claim 49, in which the remaining water with styrene is used for the production of steam for the regeneration of the synthetic hydrophobic sorbent particles.

51. A method as claimed in claim 34, in which the pressure drop across the adsorbent bed is minimized by using shallow packed adsorbent cartridges containing the synthetic hydrophobic sorbent particles.

52. A method as claimed in claim 51, in which each cartridge consists of a flat bed of 2 m in length, 25 cm in width and 4 cm in height, the top and bottom of the flat bed being made of wire mesh, with the synthetic hydrophobic sorbent particles inbetween.

53. A method as claimed in claim 51, in which the cartridge dimensions are optimized with respect to pressure drop, adsorber volume and axial flow distribution.

54. A method as claimed in claim 34, in which the pressure drop across the adsorbent bed is less than 10 mbar.

55. A method as claimed in claim 1, in which a mechanical vapour recompression (MVR) technique is used.

56. A method as claimed in claim 55, in which a boiler with the mechanical vapour recompression technique is used.

57. A method as claimed in claim 55, in which a blower (in vacuum mode) is provided to decrease the boiler pressure to 800 mbar resulting in the formation of steam.

58. A method as claimed in claim 57, in which the steam formed is pumped from the boiler to the synthetic hydrophobic sorbent particles.

59. A method as claimed in claim 57, in which, due to compression of the steam, the temperature of the steam is caused to increase to about 120° C.

60. A method as claimed in claim 1, which includes the step of regenerating the synthetic hydrophobic sorbent particles by means of synthetic hydrophobic sorbent particles.

61. A method as claimed in claim 60, in which the superheated steam is condensed in a condenser.

62. A method as claimed in claim 61, in which the condenser uses cold boiling water (94° C.) from the boiler.

63. A method as claimed in claim 62, in which, while the steam is condensed in the condenser, the heat of condensation is transported to the boiling water.

64. A method as claimed in claim 1, in which energy is added to account for unavoidable heat losses.
